(19) United States
(12) Patent Application Publication
(10) Pub. No.: US 2004/0176040 A1
(43) Pub. Date: Sep. 9, 2004

(54) Performance statistics collection for wireless service providers

(75) Inventors: Melissa Thornton, Chandler, AZ (US); Thomas Paul Hagstrom, Chandler, AZ (US); Michael K. Sprenger, Mesa, AZ (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., Schaumburg, IL

(21) Appl. No.: 10/374,254

(22) Filed: Feb. 26, 2003

(51) Int. Cl. H04B 17/00

(52) U.S. Cl. 455/67.11; 455/403

(57) ABSTRACT

A system, method and computer readable medium for measuring quality of service provided by a wireless network is disclosed. The method on a wireless device includes determining quality information associated with performance of a communications channel between a wireless device and the wireless network. The method further includes determining as location information a location of the wireless device where the quality information was determined and determining as time information a time when the quality information was determined. The method further includes transmitting from the wireless device to the wireless network the quality information, the location information and the time information.

### FIELD OF THE INVENTION

The present invention generally relates to the field of wireless communications, and more particularly relates to statistics collection by wireless service providers.

### BACKGROUND OF THE INVENTION

With the advent of pagers and mobile phones the wireless service industry has grown into a multi-billion dollar industry. The bulk of the revenues for Wireless Service Providers (WSPs) originates from subscriptions. As such, a WSP's ability to run a successful network is dependent on the quality of service provided to subscribers. The quality of service is strongly correlated to the radio frequency (RF) coverage provided by the wireless network. Identifying locations with poor network RF coverage is an ongoing problem for WSP's. The traditional approach to identifying locations with poor network RF coverage is to perform drive testing to determine wireless network RF coverage issues. Drive testing involves engineers driving in automobiles in wireless network coverage areas with radio equipment used for testing RF coverage. This process is expensive, slow, and very labor-intensive. Additionally, testing of network RF coverage is problematic since the physical environment is dynamic due to construction, seasonal foliage, base station reconfiguration and so forth.

Depending on customer complaints to identify locations with poor network RF coverage is an inadequate solution because the network problem must reach a severe state before customers complain. Additionally, by the time customers complain, they may have already decided to change to a different WSP.

There are wireless devices today that collect and store some data relative to the performance of the individual mobile units, such as integrated digital enhanced network (iDEN) and code division multiple access (CDMA) wireless devices. The data stored by these wireless devices is presently only used to control an existing data link, in which case it is typically consumed as it is used, and not stored further. In addition, iDEN and CDMA wireless devices store the number of times the paging channel is lost, the number of mobile station idle handoffs, the number of times that the mobile station declared a loss of the Forward Common Control Channel and the number of times the mobile station declared a loss of the Broadcast Control Channel. This data is stored in the form of a counter and is cleared during power down de-registration or when the base station commands the phone to clear it. This data is not collected, and does not include position data. In conventional iDEN and CDMA wireless networks, the base station does collect a status message from the wireless devices. This status message provides some information about the network infrastructure but lacks location and time information, so that it cannot be used to accurately identify a location with poor network RF coverage.

Therefore a need exists to overcome the problems with the prior art as discussed above.

### SUMMARY OF THE INVENTION

Briefly, in accordance with the present invention, disclosed is a system, method and computer readable medium for measuring quality of service provided by a wireless network. In an embodiment of the present invention, the method on a wireless device includes determining quality information associated with performance of a communications channel between a wireless device and the wireless network. The method further includes determining as location information a location of the wireless device where the quality information was determined and determining as time information a time when the quality information was determined. The method further includes transmitting from the wireless device to the wireless network the quality information, the location information and the time information.

In another embodiment of the present invention, a wireless device for measuring quality of service provided by a wireless network includes a processor for determining quality information associated with performance of a communications channel between a wireless device and the wireless network, location information of the wireless device where the quality information was determined and time information of the wireless device when the quality information was determined. The wireless device further includes a transmitter for transmitting to the wireless network the quality information, the location information and the time information.

The preferred embodiments of the present invention are advantageous because the information received from the wireless devices can be used to identify and report locations and/or times where the quality of service of the communications channel provided by the wireless network of the wireless service provider is below a predetermined standard. Thus, the present invention enables a wireless service provider to proactively manage the quality of service of the wireless network by analyzing subscriber performance data that is correlated with location and time information. The received information is a collection of the wireless device performance history and does not require costly, time-consuming drive testing or customer involvement. This allows the wireless service provider to be proactive in correcting network problems and improving the quality of service to its subscribers. Thus, there is both an improvement in network performance and a reduction in network operating cost.

Additionally, in preferred embodiments of the present invention, an independent computer system, such as a quality measurement server or statistics collection server, is used for performing processes of the present invention. That is, the computer system performing processes of the present invention operates independently from the wireless service provider, eliminating the need for costly changes to the infrastructure of the wireless network of the wireless server provider and the need for extensive compatibility testing between the system performing the additional functions of the present invention and the core wireless network of the service provider. This reduces implementation and maintenance costs.

Further, implementation of the present invention in current wireless networks requires minimal costs, as most future mobile devices will already incorporate location determination modules and additional memory to store this information.

### BRIEF DESCRIPTION OF THE DRAWINGS

FIG. 1 is a block diagram illustrating a wireless communication system according to a preferred embodiment of the present invention.

FIG. 2 is a more detailed block diagram of the wireless communication system of FIG. 1.

FIG. 3 is a block diagram illustrating a wireless device according to a preferred embodiment of the present invention.

FIG. 4 is a more detailed block diagram illustrating the wireless device of FIG. 3.

FIG. 5 is a block diagram illustrating data exchange by a wireless device according to a preferred embodiment of the present invention.

FIG. 6A is an operational flow diagram showing one portion of the data storage and exchange process of a wireless device according to a preferred embodiment of the present invention.

FIG. 6B is an operational flow diagram showing another portion of the data storage and exchange process of a wireless device according to a preferred embodiment of the present invention.

FIG. 7 is an operational flow diagram showing a data retrieval process according to a preferred embodiment of the present invention.

### DETAILED DESCRIPTION

The present invention, according to a preferred embodiment, overcomes problems with the prior art by allowing for the collection of network performance data along with location and time information in order to identify locations and times when the quality of service provided by the wireless service provider to wireless devices is below a predetermined standard.

FIG. 1 is a block diagram illustrating a wireless communication system according to a preferred embodiment of the present invention. The exemplary wireless communication system of FIG. 1 includes a wireless service provider 102, a QMS (quality measurement server or statistics collection server) 103, a wireless network 104 and wireless devices 106 through 108. The wireless service provider 102 is a first-generation analog mobile phone service, a second-generation digital mobile phone service or a third-generation Internet-capable mobile phone service.

The exemplary wireless network 104 is a mobile phone network, a mobile text messaging device network, a pager network, or the like. Further, the communications standard of the wireless network 104 of FIG. 1 is Code Division Multiple Access (CDMA), Time Division Multiple Access (TDMA), Global System for Mobile Communications (GSM), General Packet Radio Service (GPRS), Frequency Division Multiple Access (FDMA) or the like. The wireless network 104 supports any number of wireless devices 106 through 108, which are mobile phones, text messaging devices, handheld computers, pagers, beepers, or the like.

QMS 103 is a server or other system for capturing and processing quality of service information from wireless devices 106 through 108. The functions and processes of QMS 103 are described in greater detail below. In one embodiment of the present invention, QMS 103 includes one or more Personal Computers (PCs) (e.g., IBM or compatible PC workstations running the Microsoft Windows operating system, Macintosh computers running the Mac OS operating system, PCs running the LINUX operating system or equivalent), or any other computer system. In another embodiment of the present invention, QMS 103 is one or more server systems (e.g., SUN Ultra workstations running the SunOS or AIX operating system, IBM RS/6000 workstations and servers running the AIX operating system or servers running the LINUX operating system).

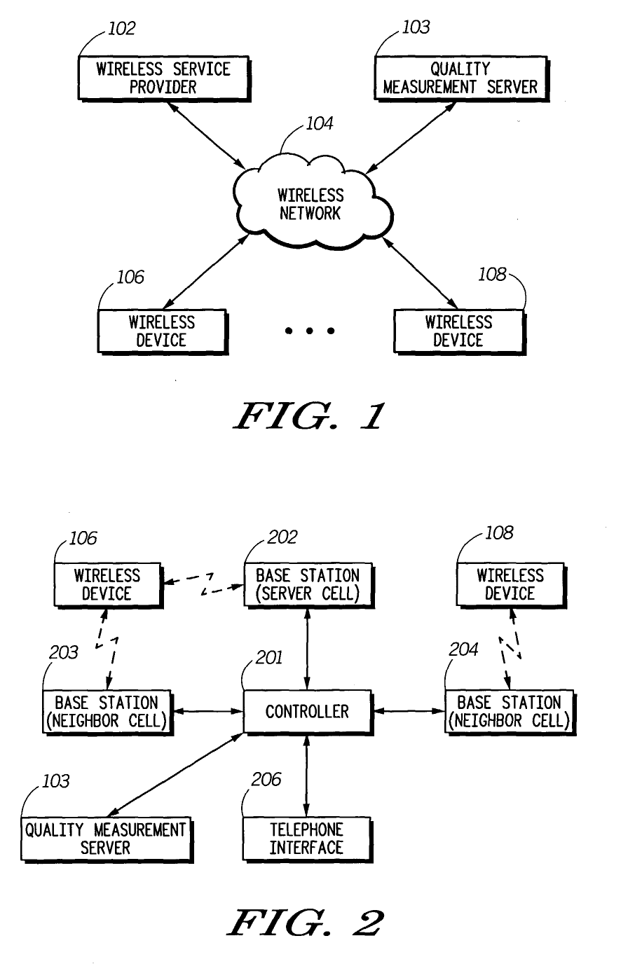

FIG. 2 is a more detailed block diagram of the wireless communication system of FIG. 1. The wireless communication system of FIG. 2 includes a controller 201 coupled to base stations 202, 203, and 204. In addition, the wireless communication system of FIG. 2 is interfaced to an external network through a telephone interface 206. The base stations 202, 203, and 204 individually support portions of a geographic coverage area containing subscriber units or transceivers (i.e., mobile devices) 106 and 108 (see FIG. 1). The mobile devices 106 and 108 interface with the base stations 202, 203, and 204 using a communication protocol, such as CDMA, FDMA, CDMA, GPRS and GSM.

The geographic coverage area of the wireless communication system of FIG. 2 is divided into regions or cells, which are individually serviced by the base stations 202, 203, and 204 (also referred to herein as cell servers). A mobile device operating within the wireless communication system selects a particular cell server as its primary interface for receive and transmit operations within the system. For example, mobile device 106 has cell server 202 as its primary cell server, and mobile device 108 has cell server 204 as its primary cell server. Preferably, a mobile device selects a cell server that provides the best communication interface into the wireless communication system. Ordinarily, this will depend on the signal quality of communication signals between a mobile device and a particular cell server.

As a mobile device moves between various geographic locations in the coverage area, a hand-off or hand-over may be necessary to another cell server, which will then function as the primary cell server. A mobile device monitors communication signals from base stations servicing neighboring cells to determine the most appropriate new server for hand-off purposes. Besides monitoring the quality of a transmitted signal from a neighboring cell server, the mobile device also monitors the transmitted color code information associated with the transmitted signal to quickly identify which neighbor cell server is the source of the transmitted signal.

FIG. 2 also shows the QMS 103 connected to controller 201. As explained above, the QMS 103 is a server for capturing and processing quality of service information from wireless devices 106 through 108. The functions and processes of QMS 103 are described in greater detail below.

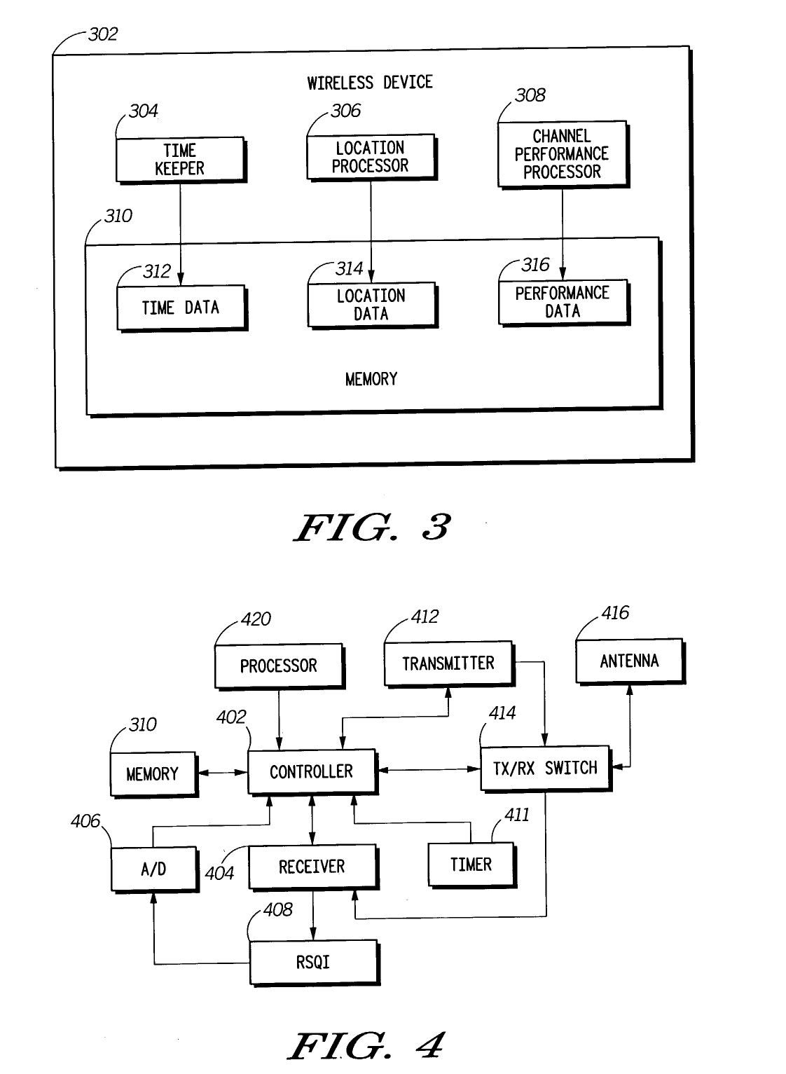

FIG. 3 is a block diagram illustrating a wireless device according to a preferred embodiment of the present invention. FIG. 3 shows a wireless device 302, such as wireless devices 106 through 108 of FIG. 1. The wireless device 302 includes a time keeper unit 304 for maintaining time information for the wireless device 302. The time keeper unit 304 is any commercially available time keeping unit, such as an ASIC, that tracks time.

The wireless device 302 further includes a location processor 306 for maintaining location information for the wireless device 302. In one embodiment, the location processor 306 is a commercially available Global Positioning System (GPS) receiver/processor for determining global positioning data of the wireless device 302. For example, in one embodiment location processor 306 is a GPS chip or chipset available from Garmin Ltd. (Olathe, Kans.). A GPS receiver/processor subscribes to the GPS system, which currently is a satellite-based navigation system made up of a network of 24 satellites placed into orbit by the U.S. Department of Defense.

In another embodiment, the location processor 306 is a processor for determining location data of the wireless device 302 using triangulation with the base stations of the wireless communications network. Such use of triangulation with the base stations of a wireless communications network to determine the location of a wireless device subscribing to the network is well known to one of ordinary skill in the art. In this embodiment, the location processor 306 is embodied in software, hardware (such as an ASIC) or a combination of the two.

In another embodiment, the location processor 306 is a processor for determining location data of the wireless device 302 using radio location with the base stations of the wireless communications network. Such use of radio location with the base stations of a wireless communications network to determine the location of a wireless device subscribing to the network is well known to one of ordinary skill in the art. In this embodiment, the location processor 306 is embodied in software, hardware (such as an ASIC) or a combination of the two.

In yet another embodiment of the present invention, the time keeper unit 304 and the location processor 306 are integrated into one unit as time is typically transmitted by GPS satellites and during the triangulation process. In the event the location processor 306 is a GPS receiver/processor, the time keeping function is performed by the GPS receiver/processor as precise time information is transmitted by GPS satellites and typically received and processed by GPS receivers/processors. In the event the location processor 306 is a processor for determining location based on triangulation or radio location with base stations, the time keeping function is performed by the processor as precise time information is transmitted by base stations and can be received and processed by the processor. The wireless device 302 further includes a communications channel performance processor 308 for maintaining performance information for the communications channel of the wireless device 302. As explained above, the wireless device 302 subscribes to the wireless network 104. As such, the wireless network 104 provides an RF communications channel over which the wireless device 302 communicates. The channel performance processor 308 performs calculations that determine the quality of the communications channel provided by the wireless network 104. The channel performance processor 308 preferably measures the signal performance using a native link performance measurement technique, such as the radio frequency power of the communications channel (i.e., signal strength), the frame error rate of the communications channel, or the bit error rate of the communications channel. As such, the signal quality or figure of merit (FOM) of the forward link and, by inference from the radio frequency power, the reverse link is calculated.

Methods for calculating the channel performance characteristics described above are well known to one of ordinary skill in the art. The channel performance processor 308 is embodied in software, hardware (such as an ASIC), or a combination of the two.

In yet another embodiment of the present invention, the time keeper unit 304, the location processor 306 and the channel performance processor 308 are integrated into one unit. In this embodiment, the functions of all three units (the time keeper unit 304, the location processor 306 and the channel performance processor 308) are performed by one or more physical processors and/or one or more software routines.

The wireless device 302 further has a memory 310 for storing information. Memory 310 is Flash memory, other non-volatile memory, random access memory (RAM), dynamic random access memory (DRAM) or the like. Memory 310 is utilized for storing, among other things, information that is garnered by the time keeper unit 304, the location processor 306 and the channel performance processor 308. As shown, memory 310 stores time data 312, location data 314 and performance data 316.

In some embodiments, software running on a general purpose processor performs the various functions such as those of the time keeper unit 304, the location processor 306 and the channel performance processor 308 in FIG. 3. The processor can be a single processor or more than one processor for performing one or more of the functions described above with reference to FIG. 3.

FIG. 4 is a more detailed block diagram illustrating the wireless device 302 of FIG. 3. In one embodiment of the present invention, the wireless device 302 is a two-way radio capable of receiving and transmitting radio frequency signals over a communication channel under a communications protocol such as CDMA, FDMA, CDMA, GPRS or GSM. The wireless device 302 operates under the control of a controller 402 which switches the wireless device 302 between receive and transmit modes. In receive mode, the controller 402 couples an antenna 416 through a transmit/receive switch 414 to a receiver 404. The receiver 404 decodes the received signals and provides those decoded signals to the controller 402. In transmit mode, the controller 402 couples the antenna 416, through the switch 414, to a transmitter 412.

The controller 402 operates the transmitter and receiver according to instructions stored in memory 310 (see FIG. 3). Memory 310 also stores information such as that described above. The stored instructions include a neighbor cell measurement scheduling algorithm. A timer module 411 provides timing information to the controller 402 to keep track of timed events. Further, the controller 402 can utilize the time information from the timer module 411 to keep track of scheduling for neighbor cell server transmissions and transmitted color code information.

When a neighbor cell measurement is scheduled, the receiver 404, under the control of the controller 402, monitors neighbor cell servers and receives a “received signal quality indicator” (RSQI). RSQI circuit 408 generates RSQI signals representing the signal quality of the signals transmitted by each monitored cell server. Each RSQI signal is converted to digital information by an analog-to-digital converter 406 and provided as input to the controller 402. Using the color code information and the associated received signal quality indicator, the mobile device 302 determines the most appropriate neighbor cell server to use as a primary cell server when hand-off is necessary.

The wireless device 302 determines and stores a variety of information. The time keeper unit 304 determines the current time, the location processor 306 determines the location of the wireless device 302 and the channel performance processor 308 determines the performance of the communications channel provided to the wireless device by the wireless network of the wireless service provider 102. Subsequently, the time data 312, location data 314 and channel performance data 316 determined by the time keeper unit 304, the location processor 306 and the channel performance processor 308, respectively, are stored in the memory 310 of the wireless device 302.

In one embodiment of the present invention, the step of storing the information determined by the time keeper unit 304, the location processor 306 and the channel performance processor 308 is performed only when the channel performance data 316 indicates a quality of service that falls below a threshold. As described above, the channel performance data 316 determined by the channel performance processor 308 describes the quality of the communications channel provided by the wireless network 104. For example, the channel performance processor 308 calculates, among other things: the radio frequency power of the communications channel (i.e., signal strength), the frame error rate of the communications channel, and the bit error rate of the communications channel. In this embodiment, the time data 312, location data 314 and channel performance data 316 are stored in the memory 310 of the wireless device 302 when the channel performance data 316 indicates a quality of service that falls below a threshold.

For example, when the signal strength of the communications channel falls below a predetermined power level, the data 312, 314 and 316 is stored in memory 310. In another example, when the bit error rate of the communications channel is greater than a predetermined error rate, the data 312, 314 and 316 is stored in memory 310. The present embodiment stores information that allows for the identification of locations and times when the quality of service of the communications channel provided by the wireless service provider 102 is below a predetermined standard.

In another embodiment of the present invention, the storing of the information determined by the time keeper unit 304, the location processor 306 and the channel performance processor 308 is performed periodically. In this embodiment, a predetermined period of time is chosen for performing the steps of determining and storing the pertinent information. In yet another embodiment of the present invention, the storing of the data 312, 314 and 316 is performed aperiodically. In this embodiment, the steps of determining and of storing the pertinent information are performed at random or other intervals.

In yet another embodiment of the present invention, the storing of the information determined by the time keeper unit 304, the location processor 306 and the channel performance processor 308 is performed in response to requests from QMS 103. In this embodiment, QMS 103 sends a request to the wireless device 302 prompting the wireless device 302 to determine and store the pertinent information. The use of a request sent by a server is explained in greater detail below.

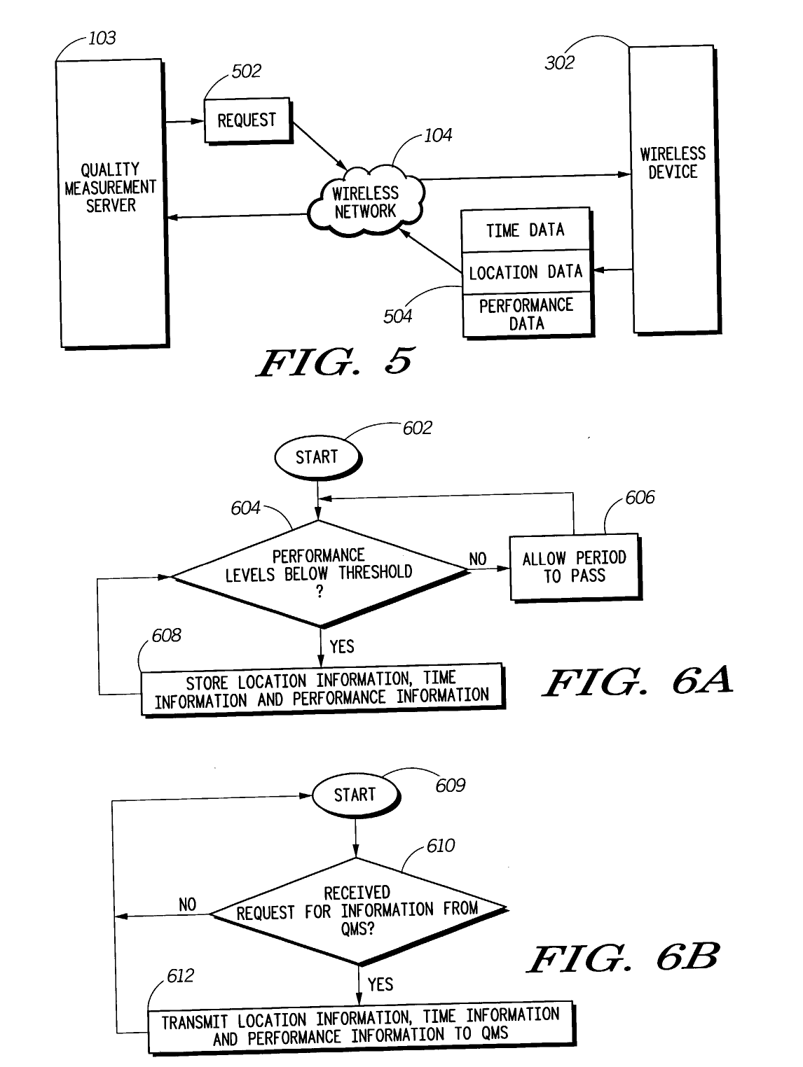

FIG. 5 is a block diagram illustrating data exchange by a wireless device according to a preferred embodiment of the present invention. FIG. 5 shows the QMS 103 and the wireless network 104 of FIG. 1. Also shown is a wireless device 302, such as the one described in greater detail in FIG. 3 and FIG. 4. FIG. 5 depicts the exchange of information between the QMS 103 and the wireless device 302, namely the information stored by the wireless device 302, as described in greater detail in FIG. 3.

In the illustrated embodiment of the present invention, the information determined by the time keeper unit 304, the location processor 306 and the channel performance processor 308 (data 312, 314 and 316, respectively) is provided by the wireless device 302 to the QMS 103 in response to a request 502 by the QMS 103. In this embodiment, the QMS 103 exchanges information and instructions with the wireless device 302 using a data packet-based data exchange protocol, such as Transmission Control Protocol over Internet Protocol (TCP/IP) or Universal Datagram Protocol (UDP) over IP.

In one embodiment, the QMS 103 sends a request 502 to the wireless device 302 using a communications protocol such as UDP over IP. The request 502 includes a request for the data 312, 314 and 316. The wireless device 302 receives the request 502 and processes it. In response to the request 502, the wireless device 302 retrieves the desired information (data 312, 314 and 316) from the memory 310 of the wireless device 302 and transmits it to the QMS 103 in a data packet 504 using a communications protocol, such as UDP over IP.

While FIG. 5 shows a transmission to QMS 103 of one data packet 504 including one set of data 312, 314 and 316 (time, location and performance data), in further embodiments of the present invention, there is transmitted more than one data packet, each including a set of data 312, 314 and 316, and/or one data packet including multiple sets of data 312, 314 and 316 for multiple performance data sets.

In an embodiment of the present invention, the QMS 103 sends a request 502 for the data 312, 314 and 316 to the wireless device 302 periodically. In another embodiment of the present invention, the QMS 103 sends a request 502 to the wireless device 302 aperiodically, or at random intervals. In another embodiment of the present invention, the QMS 103 sends a request 502 to the wireless device 302 at times when the retrieval of the data 312, 314 and 316 from the wireless device 302 will have the least impact on the wireless network 104. In an alternative, the QMS 103 sends a request 502 to the wireless device 302 for retrieval of the data 312, 314 and 316 when the wireless device 302 powers down and de-registers from the wireless network 104.

FIG. 6A is an operational flow diagram showing one portion of the data storage and exchange process of a wireless device according to a preferred embodiment of the present invention. The operational flow diagram of FIG. 6A depicts the process, on a wireless device, of determining data 312, 314 and 316 by the time keeper unit 304, the location processor 306 and the channel performance processor 308, respectively, and storing it. The operational flow diagram of FIG. 6A begins with step 602 and flows directly to step 604.

In step 604, the wireless device determines whether the quality of service of the communications channel provided to the wireless device 302 by the wireless network 104 is below a predetermined threshold. In a preferred embodiment of the present invention, the storing of the information determined by the time keeper unit 304, the location processor 306 and the channel performance processor 308 is performed only when the channel performance data 316 indicates a quality of service that falls below a threshold. If the result of the determination of step 604 is positive, the operational flow diagram of FIG. 6A flows to step 608. If the result of the determination of step 604 is negative, the operational flow diagram of FIG. 6A flows to step 606. In step 606, a period of time is allowed to pass before step 604 is repeated.

In step 608, the time keeper unit 304, the location processor 306 and the channel performance processor 308 determine data 312, 314 and 316, respectively, and subsequently the data 312, 314 and 316 is stored in the memory 310 of wireless device 302. In an embodiment of the present invention, as described above, a processor 420 (see FIG. 4) encompasses all of the functions of the location processor 306, the time keeper unit 304 and the channel performance processor 308. In this embodiment, the processor 420 determines data 312, 314 and 316 and stores it in the memory 310 of wireless device 302. In another embodiment of the present invention, as described above, data 312, 314 and 316 is determined and stored either periodically or aperiodically.

FIG. 6B is an operational flow diagram showing another portion of the data storage and exchange process of a wireless device according to a preferred embodiment of the present invention. The operational flow diagram of FIG. 6B depicts the process, on a wireless device, of transmitting data 312, 314 and 316 to the QMS 103. The operational flow diagram of FIG. 6B begins with step 609 and flows directly to step 610.

In step 610, it is determined whether a request for information has been received from the QMS 103. In preferred embodiments of the present invention, the information determined by the time keeper unit 304, the location processor 306 and the channel performance processor 308 (data 312, 314 and 316, respectively) is provided by the wireless device 302 to the QMS 103 in response to a request 502 by the QMS 103. If the result of the determination of step 610 is positive, the operational flow diagram of FIG. 6B flows to step 612. If the result of the determination of step 610 is negative, the operational flow diagram of FIG. 6B flows back to step 609.

In step 612, it has been determined that a request for information has been received from the QMS 103. As a result, the information determined by the time keeper unit 304, the location processor 306 and the channel performance processor 308 (data 312, 314 and 316, respectively) is transmitted by the wireless device 302 to the QMS 103.

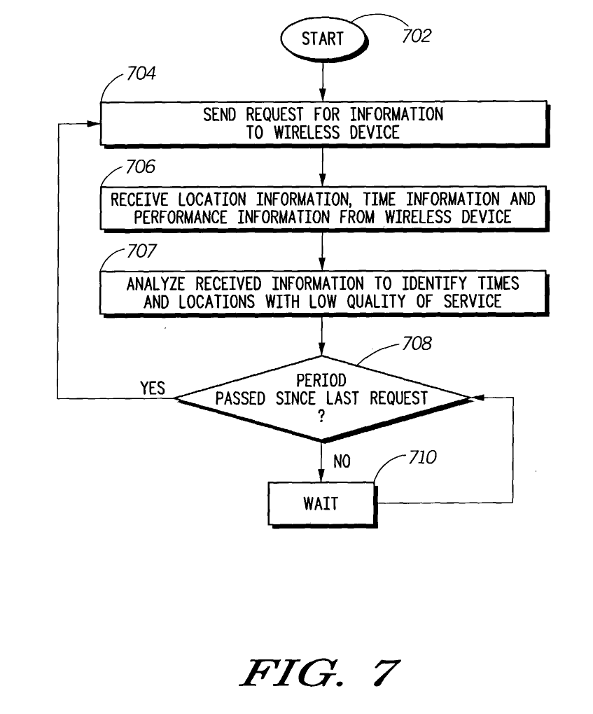

FIG. 7 is an operational flow diagram showing a data retrieval process according to a preferred embodiment of the present invention. The operational flow diagram of FIG. 7 depicts the process, in the QMS 103, of sending a request for, and receiving, data 312, 314 and 316 from the wireless device 302. The operational flow diagram of FIG. 7 begins with step 702 and flows directly to step 704.

In step 704, a request 502 for the data 312, 314 and 316 is sent from the QMS 103 to the wireless device 302. In an embodiment of the present invention, the QMS 103 sends a request 502 to the wireless device 302 periodically. In another embodiment of the present invention, the QMS 103 sends a request 502 to the wireless device 302 aperiodically, or at random intervals, or at specified times such as shutdown.

The wireless device 302 receives and processes the request 502 from the QMS 103 (as described in the process of FIG. 6B above). In response to the request 502, the wireless device 302 retrieves the desired information (data 312, 314 and 316) from the memory 310 of the wireless device 302 and transmits it to the QMS 103 in a data packet 504 using a communications protocol. The QMS 103, in step 706, receives the data packet 504 (including data 312, 314 and 316) from the wireless device 302.

The QMS 103, in optional step 707, analyzes the received information (data 312, 314 and 316) to identify times and locations where the quality of service of the communications channel provided by the wireless network 104 is below a predetermined standard. By collecting data 312, 314 and 316 from a large number of wireless devices 302, the identity of locations and/or times with sub-standard quality of service can be determined with greater accuracy. Large samples of data 312, 314 and 316 can be used to identify locations, such as areas with exorbitant foliage or areas within a valley, or times, such as rush hour on the weekdays, that have sub-standard quality of service. The wireless service provider 102 can then respond by adding additional base stations or increasing signal strength at the identified times and/or locations, in order to increase quality of service.

In an embodiment of the present invention, the server also correlates the received information (data 312, 314 and 316) with weather data and/or traffic data to identify instances, including times and locations, when the quality of service of the communications channel provided by the wireless network 104 is below a predetermined standard. In this embodiment, the QMS 103 determines and stores weather data and/or traffic data independently of the information received from the wireless devices (data 312, 314 and 316). After reception of the data 312, 314 and 316 from the wireless devices, the server proceeds to correlate data 312, 314 and 316 with weather data and/or traffic data in order to identify instances, including times and locations, when the quality of service of the communications channel provided by the wireless network 104 is below a predetermined standard.

For example, large samples of data 312, 314 and 316 can be correlated with weather data to reveal that the quality of service of the communications channel decreases during a rain storm. In another example, large samples of data 312, 314 and 316 can be correlated with automobile traffic data to reveal that the quality of service of the communications channel decreases during times of heavy traffic because people use their wireless devices more often when they are stuck in traffic. The wireless service provider 102 can then respond by adding additional base stations or increasing signal strength, at the identified times and/or locations, in order to increase quality of service.

Returning to FIG. 7, in step 708, it is determined whether a period of time has passed since the last request 502 was transmitted to the wireless device 302 from QMS 103. Recall that in an embodiment of the present invention, the QMS 103 sends a request 502 to the wireless device 302 periodically or aperiodically. If the result of the determination of step 708 is positive, the operational flow diagram of FIG. 7 flows back to step 704. If the result of the determination of step 708 is negative, the operational flow diagram of FIG. 7 flows to step 710. In step 710, a period of time is allowed to pass before step 708 is repeated.

In preferred embodiments of the present invention, the QMS is an independent computer system. That is, the QMS operates independently from the infrastructure of the wireless service provider's wireless network, eliminating the need for costly changes to the infrastructure of the wireless server provider's wireless network, and the need for extensive compatibility testing between the system performing the additional functions of the present invention and this infrastructure. This reduces implementation and maintenance costs. It also allows for easier integration of the QMS into existing wireless networks.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product (at the wireless device 302 and/or QMS 103), which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for measuring quality of service provided by a wireless network, comprising:
determining quality information associated with performance of a communications channel between a wireless device and the wireless network;
determining as location information a location of the wireless device where the quality information was determined; and
determining as time information a time when the quality information was determined; and
transmitting from the wireless device to the wireless network the quality information, the location information and the time information.

2. The method of claim 1, wherein the quality information includes at least one of:
radio frequency power of the communications channel;
a frame error rate of the communications channel;
a bit error rate of the communications channel; and
a signal quality index.

3. The method of claim 1, wherein the step of determining location information is performed using a Global Positioning System receiver/processor.

4. The method of claim 1, wherein the step of determining location information is performed using a processor for performing triangulation with base stations of the wireless network.

5. The method of claim 1, further comprising the step of:
receiving a request from the wireless network for the quality information.

6. The method of claim 5, further comprising the step of:
storing the quality information, location information and time information until the request is received from the network.

7. The method of claim 1, wherein the transmitting step is performed when the wireless device is shut down.

8. The method of claim 7, wherein the step of determining location information and determining time information are performed when performance of the communications channel falls below a predetermined threshold.

9. A wireless device for measuring quality of service provided by a wireless network, comprising:
a processor for determining:
quality information associated with performance of a communications channel between a wireless device and the wireless network;
location information of the wireless device where the quality information was determined; and
time information of the wireless device when the quality information was determined, and
a transmitter for transmitting to the wireless network the quality information, the location information and the time information.

10. The wireless device of claim 9, wherein the quality information includes at least one of:
radio frequency power of the communications channel;
a frame error rate of the communications channel;
a bit error rate of the communications channel; and
a signal quality index.

11. The wireless device of claim 9, wherein the determining of location information is performed using a Global Positioning System receiver/processor.

12. The wireless device of claim 9, wherein the determining of location information is performed using a processor for performing triangulation with base stations of the wireless network.

13. The wireless device of claim 9, further comprising:
a receiver for receiving a request from the wireless network for the quality information.

14. The wireless device of claim 13, further comprising:
memory for storing the quality information, location information and time information until the request is received from the network.

15. The wireless device of claim 9, wherein the transmitting of the transmitter transmits the quality information, the location information and the time information to the wireless network when the wireless device is shut down.

16. The wireless device of claim 15, wherein the determining of location information and determining of time information are performed when performance of the communications channel falls below a predetermined threshold.

17. A method for measuring quality of service provided by a wireless network, comprising:
transmitting a request to at least one wireless device for quality information stored by the at least one wireless device;
receiving from the at least one wireless device:
performance information associated with performance of a communications channel between the at least one wireless device and the at least one wireless network;
location information indicating a location of the at least one wireless device where the performance information was determined; and
time information indicating a time when the performance information was determined.

18. The method of claim 17, further comprising the step of:
correlating performance information received from a plurality of wireless devices to identify locations and/or times when quality of service of the wireless network is below a predetermined standard.

19. The method of claim 18, wherein the transmitting step is executed periodically.

20. The method of claim 18, wherein the transmitting step is executed aperiodically.

21. The method of claim 17, wherein the performance information includes at least one of:
radio frequency power of the communications channel;
a frame error rate of the communications channel;
a bit error rate of the communications channel; and
a signal quality index.

22. The method of claim 17, wherein the performance information received from a plurality of wireless devices is correlated with weather information.

23. The method of claim 17, wherein the performance information received from a plurality of wireless devices is correlated with traffic information.
